(19) United States
(12) Patent Application Publication
(10) Pub. No.: US 2025/0314907 A1
(43) Pub. Date: Oct. 9, 2025

(54) DEEP SURFACE LIQUID CRYSTAL DISPLAY

(71) Applicant: Brown University, Providence, RI (US)

(72) Inventor: Ian GONSHER, Westford, MA (US)

(21) Appl. No.: 19/172,430

(22) Filed: Apr. 7, 2025

Related U.S. Application Data
(60) Provisional application No. 63/631,968, filed on Apr. 9, 2024.

(51) Int. Cl. G02B 30/54; G02F 1/1333; G02F 1/1347; G09G 3/00; H04N 13/189; H04N 13/388

(52) U.S. Cl. CPC G02B 30/54; G02F 1/133308; G02F 1/1347; G09G 3/003; H04N 13/189; H04N 13/388

(57) ABSTRACT

A deep surface liquid crystal display system includes a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame.

### CROSS REFERENCE TO RELATED APPLICATIONS

This application claims benefit from U.S. Provisional Patent Application Ser. No. 63/631,968, filed Apr. 9, 2024, which is incorporated by reference in its entirety.

### STATEMENT REGARDING FEDERALLY SPONSORED RESEARCH

Not applicable.

### BACKGROUND OF THE INVENTION

The present invention relates generally to display devices, and more particularly to a deep surface liquid crystal display.

In general, a volumetric display device is a display device that forms a visual representation of an object in three physical dimensions, as opposed to the planar image of traditional screens that simulate depth through a number of different visual effects.

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a deep surface liquid crystal display system including a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame.

In another aspect, the invention features a method including providing a deep surface liquid crystal display system, the deep surface liquid crystal display system including a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame, and playing two videos files on the first liquid crystal display (LCD) screen and the second liquid crystal display (LCD) screen simultaneously.

In still another aspect, the invention features a method including providing a deep surface liquid crystal display system, the deep surface liquid crystal display system including a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame, separating a background field from a foreground image, and playing two videos on the first liquid crystal display (LCD) screen and the second liquid crystal display (LCD) screen simultaneously.

In yet another aspect, the invention features a method including providing a deep surface liquid crystal display system, the deep surface liquid crystal display system including a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame, and playing two video files in sequence to create a leaping effect of a smaller background image moving forward toward a viewer and becoming a larger foreground image on the first LCD screen.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE SEVERAL VIEWS OF THE DRAWING

These and other features, aspects, and advantages of the present invention will become better understood with reference to the following description, appended claims, and accompanying drawings where:

FIG. 1 is a block diagram.

FIG. 2 is a flow diagram.

FIG. 3 is a flow diagram.

FIG. 4 is a flow diagram.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Representing depth on a surface has been a design concern since at least the Renaissance. And yet, despite this long history, three dimensional (3D) displays have not become widely adopted. However, with the emergence of mixed reality applications, the development of new modalities for providing depth to displays has become even more relevant. A typical LCD has a backlighting layer, followed by a polarized layer, a glass layer, a pixel layer, another glass layer and then another polarized layer.

The present invention is directed towards deep surface liquid crystal displays. Deep Surface Liquid Crystal Displays (DS-LCD) offer an alternative design strategy to standard LCDs with several advantages. DS-LCDs can be used as a kind of volumetric display in the z axis, employing the shallow space produced in the gap between two displays. The two (or more) layers work as substrates upon which slices of the image can be produced. But DS-LCDs can also work stereoscopically, in the y and x axes, by taking advantage of binocular effects. It doesn't require anaglyph glasses, and so it can produce a deep surface experience that is integrated directly into the built environment. This strategy eschews the pitfalls of wearables in general, such as cumbersome Augmented Reality (AR) and Virtual Reality (VR) devices that attach to the head.

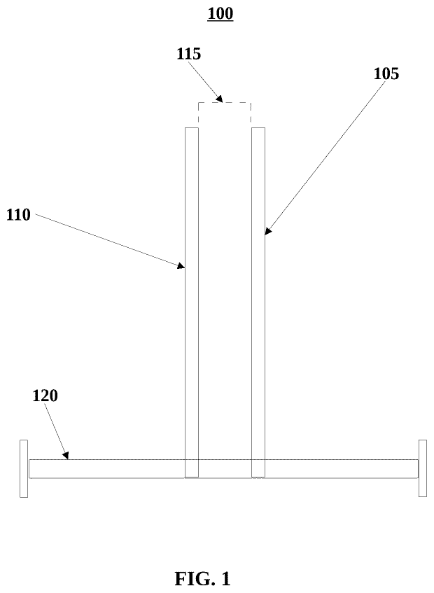

Referring now to FIG. 1, an exemplary deep surface liquid crystal display system 100 includes a first liquid crystal display (LCD) screen 105 and a second liquid crystal display (LCD) screen 110. The first LCD screen lacks 105 an opaque backing layer, making it a transparent LCD screen, while the second liquid crystal display (LCD) screen 110 includes an opaque backing layer.

More specifically, the second liquid crystal display (LCD) screen 110 is a standard unmodified LCD display. The first LCD screen 105 is modified by removing the opaque backing layer, allowing for the liquid crystal layer and polarizing layers to remain transparent. This allows for the layering, or doubling, of additional visual content onto the second liquid crystal display (LCD) screen 110.

In one embodiment, the first LCD screen 105 is layered on top of the second LCD screen 110 and separated by a gap 115. Both the first LCD screen 105 and the second LCD screen 110 are mounted on an adjustable aluminum frame 120. The adjustable aluminum frame 120 enables the gap 115 between the first LCD screen 105 and the second LCD screen 110 to be varied according to a desired effect. In embodiments, the gap ranges from 1.75 inches to 2.75 inches.

In alternative embodiments, one or more additional transparent LCD screens (i.e., those lacking opaque backing layers) are positioned in the gap 115 between the first LCD screen 105 and the second LCD screen 110.

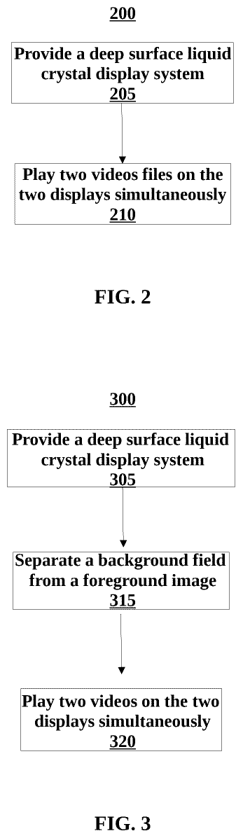

As shown in FIG. 2, a process 200 includes providing (205) a deep surface liquid crystal display system. The deep surface liquid crystal display system includes a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame.

Process 200 includes playing (210) two videos files on the first liquid crystal display (LCD) screen and the second liquid crystal display (LCD) screen simultaneously. This is accomplished by creating two windows for each video, defining the x and y coordinates for each window, and resizing and aligning each frame of the video to conform to the correct frame dimensions.

In embodiments, the two video files are selected from the two video files are selected from MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.

As shown in FIG. 3, a process 300 includes providing (305) a deep surface liquid crystal display system. The deep surface liquid crystal display system includes a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame.

Process 300 includes separating (315) a background field from a foreground image.

Process 300 includes playing (320) two videos on the first liquid crystal display (LCD) screen and the second liquid crystal display (LCD) screen simultaneously. This is accomplished by taking in a file path to read to and a file path to write to, then going through each frame of the input file and removing the background using an OpenCV module cv2. The extracted foreground image can then be played on the first (transparent) LCD screen, while the background image can then be played on the second LCD screen. In videoconferencing applications, this separates the image of a person from the background, giving a deeper spatial effect.

In embodiments, the two video files are selected from the two video files are selected from MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.

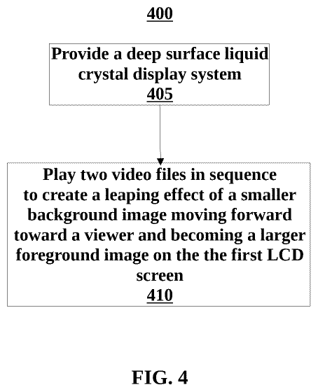

As shown in FIG. 4, a process 400 includes providing (405) a deep surface liquid crystal display system. The deep surface liquid crystal display system includes a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame.

Process 400 includes playing (410) two video files in sequence to create a leaping effect of a smaller background image moving forward toward a viewer and becoming a larger foreground image on the first LCD screen. This is accomplished by splitting a video into two files that can be played on the first liquid crystal display (LCD) screen and the second liquid crystal display (LCD) screen sequentially. A smaller image on the second LCD screen jumps forward onto the first LCD screen, increasing slightly in size to further enhance the effect of an object coming towards a viewer.

In embodiments, the two video files are selected from the two video files are selected from MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.

In summary, the present invention enables layered transparent LCD displays to produce greater depth by combining both stereoscopic and volumetric approaches. The effect is something akin to looking into clear water from the shore. On the surface plane of the x and y axes, unadulterated images or stereoscopic images are used to enhance binocular effects, while the shallow space in the z axis-in the physical gap between displays-can produce a very convincing volumetric effect.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A deep surface liquid crystal display system comprising:
a first liquid crystal display (LCD) screen, the first LCD screen lacking an opaque backing layer;
a second liquid crystal display (LCD) screen, the first LCD screen layered on top of the second LCD screen separated by a gap; and
an adjustable aluminum frame, the first LCD screen and the second LCD screen mounted onto the adjustable aluminum frame.

2. The deep surface liquid crystal display system of claim 1 wherein the adjustable aluminum frame enables varying a size of the gap.

3. The deep surface liquid crystal display system of claim 2 wherein the gap ranges from 1.75 inches to 2.75 inches.

4. The deep surface liquid crystal display system of claim 1 further comprising one or more additional transparent LCD screens positioned in the gap between the first LCD screen and the second LCD screen.

5. A method comprising:
providing a deep surface liquid crystal display system, the deep surface liquid crystal display system comprising a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame; and
playing two videos files on the first liquid crystal display (LCD) screen and the second liquid crystal display (LCD) screen simultaneously.

6. The method of claim 5 wherein the two video files are selected from the group consisting of MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.

7. A method comprising:
providing a deep surface liquid crystal display system, the deep surface liquid crystal display system comprising a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame;
separating a background field from a foreground image; and
playing two videos on the first liquid crystal display (LCD) screen and the second liquid crystal display (LCD) screen simultaneously.

8. The method of claim 7 wherein the two video files are selected from the group consisting of MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.

9. A method comprising:
providing a deep surface liquid crystal display system, the deep surface liquid crystal display system comprising a first liquid crystal display (LCD) screen, the first LCD screen lacking an opaque backing layer, a second liquid crystal display (LCD) screen, the first LCD screen layered on top of the second LCD screen separated by a gap, and an adjustable aluminum frame, the first LCD screen and the second LCD screen mounted onto the adjustable aluminum frame; and
playing two video files in sequence to create a leaping effect of a smaller background image moving forward toward a viewer and becoming a larger foreground image on the first LCD screen.

10. The method of claim 7 wherein the two video files are selected from the group consisting of MPEG-4 Part 14 (MP4) files, Audio Video Interleave (AVI) files, QuickTime File Format (MOV) files, windows Media Video (WMV) files, Matroska Multimedia Container (MKV) files, Flash Video (FLV) files, Moving Picture Experts Group (MPEG) files and Third Generation Partnership Project (3GP) files.
